(19) United States
(12) Patent Application Publication
(10) Pub. No.: US 2026/0063794 A1
(43) Pub. Date: Mar. 5, 2026

(54) InSAR-based Measurement Method for Angle of Critical Deformation in Coal Mining Area and System

(71) Applicant: Guizhou Power Grid Co., Ltd., Guiyang (CN)

(72) Inventors: Yu WU, Guiyang (CN); Qing LIU, Guiyang (CN); Yi LI, Guiyang (CN); Shuyi ZHENG, Guiyang (CN); Jianrong WU, Guiyang (CN); Xiaohu ZHENG, Guiyang (CN); Xianglun NIE, Guiyang (CN); Jie HUANG, Guiyang (CN); Dengsheng CAI, Guiyang (CN); Huan HUANG, Guiyang (CN); Hao DU, Guiyang (CN); Shouchang WU, Guiyang (CN); Rongjun HU, Guiyang (CN); Qi YANG, Guiyang (CN); Xianyin MAO, Guiyang (CN); Qianyong LV, Guiyang (CN); Yao ZHONG, Guiyang (CN); Qian JIANG, Guiyang (CN); Dandan LIU, Guiyang (CN)

(21) Appl. No.: 19/381,438

(22) Filed: Nov. 6, 2025

Related U.S. Application Data
(63) Continuation of application No. PCT/CN2024/118352, filed on Sep. 11, 2024.

(30) Foreign Application Priority Data
Nov. 16, 2023 (CN) 202311531174.6

(51) Int. Cl. G01S 13/90

(52) U.S. Cl. CPC G01S 13/9023; G01S 13/9094

(57) ABSTRACT

The present invention discloses an InSAR-based measurement method and system for angle of critical deformation in a coal mining area, and relates to the technical field of geological disaster prevention and control of mountainous coal mines, comprising: acquiring a mining surface deformation field image using a small baseline subset interferometric synthetic aperture radar; and drawing profile lines along the strike direction and dip direction of the coal seam respectively in the mining surface deformation field image. The method provided by the present invention has the advantages of improving time resolution and reducing phase noise.

### CROSS-REFERENCE TO RELATED APPLICATIONS

The present application is a continuation of International Application No. PCT/CN2024/118352, filed on Sep. 11, 2024, and claims priority to Chinese Patent Application No. 202311531174.6, filed on Nov. 16, 2023, the entire disclosure of which is incorporated herein by reference.

### TECHNICAL FIELD

The present invention relates to the technical field of geological disaster prevention and control of maintenances coal mines, and in particular to an InSAR-based measurement method for angle of critical deformation in a coal mining area and system.

### BACKGROUND

Surface subsidence in coal mining areas is one of the most common and typical geological disasters, which is caused by continuous deformation of the earth surface due to underground mining activities, accompanied by the risk of secondary disasters such as landslides, collapses and debris flows. The large-scale exploitation of coal resources has made an indelible contribution to the development of national economy and provided a strong guarantee for the rapid development of the society and economy in China. Data from the National Bureau of Statistics shows that in 2022, China produced 4.50 billion tons of raw coal, with a year-on-year increase of 9.0%, and imported 290 million tons of coal, with a year-on-year decrease of 9.2%.

However, with the extensive exploitation of coal resources, geological disasters occur frequently in the mining areas of coal mines in China. Such damage can cause deformation and displacement of the rock mass, and eventually lead to subsidence of the surface above the goafs. The key to solving these problems lies in the determination of mining subsidence parameters. Mining subsidence parameters are related to factors such as the moving basin, the extent of subsidence, the strike and dip direction of the coal seam, and the characteristics of the overlying strata. After coal mining, two profiles parallel to the strike and dip direction of the coal seam are taken on the subsidence and movement basin surface. The positional relationship between the movement basin and the two profiles can be observed. Based on the relationship, the angle of critical deformation can be calculated.

The current methods commonly used for obtaining surface movement parameters include numerical simulation, similar material, and observation stations for rock layer movement. The present invention adopts the InSAR technology to obtain surface movement parameters. The commonly used methods for observing the surface subsidence in the study area include leveling measurement, global positioning system (GPS), total station measurement, and the like. However, these methods are difficult to accurately extract the complete characteristics of spatial surface subsidence, and have limitations such as a small detection range, high cost, and high manpower consumption. The InSAR technology is widely used in obtaining large-scale and high-precision deformation data. Some studies have utilized D-InSAR monitoring based on time series to detect subsidence caused by underground coal mining activities in mountainous areas, and have obtained parameters such as influence angles, traction angles, and starting distances at different mining stages. Some technicians have also developed a new method based on time-series synthetic aperture radar image sets to monitor the surface subsidence caused by mining, thereby obtaining the average subsidence rate of the mine over the years. However, the D-InSAR technology is prone to causing phase decorrelation and is limited by factors such as atmospheric delay, and thus cannot provide continuous time-series deformation data.

### SUMMARY

In view of the existing problems above, the present invention is disclosed.

Therefore, the technical problem solved by the present invention is that conventional methods for measuring the angle of critical deformation in coal mining areas have the drawbacks of low accuracy and low efficiency, being difficult to monitor and predict surface movement and deformation in the coal mining areas in real time and accurately, resulting in the inability to promptly prevent and handle geological disasters caused by surface movement.

In order to solve the above technical problems, the present invention provides the following technical solutions: an InSAR-based measurement method for angle of critical deformation in a coal mining area, including:
acquiring a mining surface deformation field image using a small baseline subset interferometric synthetic aperture radar; drawing profile lines along the strike direction and dip direction of the coal seam respectively in the mining surface deformation field image, and selecting n target deformation points as monitoring points on the profile lines respectively; carrying out two-dimensional decomposition ignoring north-south directional deformation contribution on monitoring point data according to satellite incidence angles and satellite fly directions and azimuth angles, so as to obtain vertical and horizontal deformation values; calculating incline, curvature and horizontal deformation parameters with the combination of vertical and horizontal deformation results of two-dimensional decomposition according to a probability integral method; and drawing a curve chart according to vertical deformation of a target area and parameters above, and acquiring a corresponding angle of critical deformation value in a study scope within 10 mm of vertical deformation with strike and dip profile maps.

As an optimal solution of the InSAR-based measurement method for angle of critical deformation in the coal mining area of the present invention, the acquiring the mining surface deformation field image includes image calibration, interference handling, coherent phase analysis and data interpretation; the image calibration includes atmospheric calibration and radiation calibration; the interference handling includes calculating interference images at different time points; the coherent phase analysis includes acquiring coherent phase history of each pixel and detecting surface displacement signals; the data interpretation includes acquiring lifting and subsidence phenomena of the target area according to data; and the selecting n target deformation points as monitoring includes taking the length through the goaf of the strike and dip direction profile lines of the coal seam, wherein the profile lines are of equal length, so that the number of monitoring points are equal.

As an optimal solution of the InSAR-based measurement method for angle of critical deformation in the coal mining area of the present invention, the two-dimensional decomposition is expressed as:

$$\{ \begin{matrix}{D}_{{T}_{1} , {T}_{2}} = {d}_{U} cos θ − {d}_{E} sin θ cos ( α − \frac{3}{2} π ) \\ {D}_{{T}_{1}^{′} , {T}_{2}^{′}}^{′} = {d}_{U} cos {θ}^{′} − {d}_{E} sin {θ}^{′} cos ( {α}^{′} − \frac{3}{2} π )\end{matrix} \}$$

wherein θ represents the incidence angle of a satellite image; represents the included angle of the satellite fly direction and the north direction; α-3/2π represents the included angle of the projection angle and the north direction in the satellite sight direction on the ground; T₁ and T₂ represent the acquisition time of two-scene satellite data of a same ascending; D_{T1,T2} represents deformation of the radar sight direction within the time from T₁ to T₂; d_{U} represents the deformation in the vertical direction; d_{E} represents the deformation in the horizontal east-west direction; the deformation of the descending radar sight direction is D′_{T1,T2}; T₁′ and T₂′ respectively represent acquisition time of data; θ′ represents an incidence angle of a satellite descending image; and a and a′ respectively represent the included angle of the satellite fly direction and the north direction.

As an optimal solution of the InSAR-based measurement method for angle of critical deformation in the coal mining area of the present invention, the probability integral method is expressed as:

$$W ( x , z ) = {W}_{0} ( \frac{1}{\sqrt{π}} {\int }_{0}^{\frac{\sqrt{π x}}{{r}_{z}}} {e}^{− {λ}^{2}} d λ + \frac{1}{2} )$$

$$i ( x , z ) = \frac{d W}{d x} = \frac{{W}_{0}}{{r}_{z}} {e}^{\frac{π {x}^{2}}{{r}_{s}^{2}}}$$

$$k ( x , z ) = \frac{d i}{d x} = − \frac{2 {W}_{0} π x}{{r}_{z}^{3}} {e}^{\frac{π {x}^{2}}{{r}_{s}^{2}}}$$

$$U ( x , z ) = {B}_{z} \frac{d W}{d x} = \frac{{B}_{z} {W}_{0}}{{r}_{z}} {e}^{− \frac{π {x}^{2}}{{r}_{s}^{2}}}$$

$$ε ( x , z ) = \frac{d U}{d x} = − \frac{2 {W}_{0} {B}_{z} π x}{{r}_{z}^{3}} {e}^{− \frac{π x 2}{{r}_{s}^{2}}}$$

$${W}_{0} = mq cos α$$

$${r}_{z} = \sqrt{4 A π} = \frac{H}{tan β}$$

wherein W₀ is a maximum surface subsidence value; r_{z} is a main radius of influence; λ is a horizontal integral distance; m is an ore mining depth; q is a subsidence coefficient; α is an ore bed dip; A is a constant; H is a mining depth; tanβ is a main influence angle tangent value; i represents incline; k represents curvature; U represents a horizontal displacement value; B_{z} represents a horizontal movement coefficient; and & represents horizontal deformation.

As an optimal solution of the InSAR-based measurement method for angle of critical deformation in the coal mining area of the present invention, the angle of critical deformation is that under the circumstance of full subsidence, critical deformation values are calculated and dangerous moving boundaries are determined using a group of critical deformation values under current criteria,

$$i = \pm 3 mm / m , ε = \pm 2 mm / m , k = \pm 0.2 ⋆ {10}^{− 3} / m$$

generate cross points, the outermost point of all cross points of the critical deformation values within 10 mm is projected vertically onto a connecting line of a ground point and a boundary point of the goaf, and then the included angle formed by the connecting line and the horizontal line is the angle of critical deformation.

As an optimal solution of the InSAR-based measurement method for angle of critical deformation in the coal mining area of the present invention, the angle of critical deformation includes that on the basis of taking points on defined angle of critical deformation, if the vertical subsidence curve exceeds 10 mm on the outermost side of the profile, an outermost point of the cross point of the critical deformation curve is selected, and the included angle of the connecting point passing through the point and the outermost cross point of a target coal seam and the horizontal line is the angle of critical deformation.

As an optimal solution of the InSAR-based measurement method for angle of critical deformation in the coal mining area of the present invention, the angle of critical deformation further includes that when goafs that the profile lines pass through are not consecutive, according to time sections reaching sufficient subsidence, corresponding coal seams and subsidence curve fluctuation trend, a cross point of the critical deformation value is vertically projected onto the ground point, and the included angle of the connecting line of the point and the outermost cross point of the target coal seam and the horizontal line is the angle of critical deformation.

The other purpose of the present invention is to provide an InSAR-based measurement system for angle of critical deformation in a coal mining area, by establishing a coal mine angle of critical deformation measurement system, being capable of solving the problem of accurately and efficiently monitoring and analyzing surface movement and deformation in coal mining areas under complicated geographic conditions, thereby improving the prevention and handling capability of geological disasters.

In order to solve the above technical problems, the present invention provides the following technical solutions An InSAR-based measurement system for angle of critical deformation in a coal mining area, including: a data acquisition module, a deformation field analysis module, a deformation parameter calculation module and an angle of critical deformation value extraction module, wherein the data acquisition module is used for acquiring InSAR satellite data, carrying out atmospheric and radiation calibration, calculating interference images at different time points, analyzing coherent phase history of each pixel, and detecting surface displacement signals; the deformation field analysis module is used for analyzing processed data using the small baseline subset interferometric synthetic aperture radar, extracting surface deformation information, drawing profile lines in coal seam strike and dip directions, and selecting monitoring points; the deformation parameter calculation module is used for calculating incline, curvature and horizontal deformation parameters based on two-dimensional decomposition results with the probability integral method by examining satellite incidence angles and fly direction and azimuth angles; and the angle of critical deformation value extraction module is used for drawing a curve chart and determining an angle of critical deformation value according to vertical deformation and other parameters obtained through calculation, and illustrating data in graphs.

A computer device, comprising a memory and a processor, wherein the memory is used for storing computer programs; and the steps of the InSAR-based measurement method for angle of critical deformation in the coal mining area are achieved when the computer programs are executed by the processor.

A computer readable storage medium, with computer programs stored thereon, wherein the steps of the InSAR-based measurement method for angle of critical deformation in the coal mining area are achieved when the computer programs are executed by the processor.

The present invention has the beneficial effects that: compared with the conventional D-InSAR technology, the InSAR-based measurement method for angle of critical deformation in the coal mining area provided by the present invention is that the SBAS-InSAR technology adopted in the method inherits advantages of the conventional InSAR, meanwhile has the advantages of being high in time resolution and reducing phase noise, solving the problems that the D-InSAR technology is prone to causing phase decorrelation and is limited by factors such as atmospheric delay, and thus cannot provide continuous time-series deformation data.

Compared with traditional technologies such as numerical simulation, similar material, and observation stations with rock strata movement methods, the SBAS-InSAR technology adopted in the method has the advantages of being high in precision and high in efficiency, solving a series of problems such as the small detection range, high cost, and large human resource consumption of traditional methods.

Compared with the single SBAS-InSAR technology, the method combines SBAS-InSAR technology with GIS technology. The SBAS-InSAR technology is used to extract surface deformation, while the GIS technology classifies and displays the surface deformation values extracted by the SBAS-InSAR technology and extracts profile data, thereby obtaining an Excel table of clear and visible surface deformation data of the mining area and corresponding profile data. A series of problems of data display and effective summarization are resolved.

Compared with the simple 1-probability integration method, the method effectively integrates the SBAS-InSAR technology and the probability integral method. The detection accuracy of the SBAS-InSAR technology can reach the millimeter level. With the combination of advantages of fast convergence and high accuracy of the probability integration method, the obtained mobile parameter results are more reliable.

### BRIEF DESCRIPTION OF DRAWINGS

In order to describe the technical solutions in the examples of the present disclosure more clearly, a brief description of the accompanying drawings required for describing the examples will be provided below. Obviously, the accompanying drawings in the following description show merely some examples of the present disclosure. Those of ordinary skill in the art can also derive other accompanying drawings from these accompanying drawings without making creative efforts.

FIG. 1 is an overall flow chart of an InSAR-based measurement method for angle of critical deformation in a coal mining area provided by one embodiment of the present invention;

FIG. 2 is a comparison diagram of load balancing rate of multiple algorithm under same task requests of an InSAR-based measurement method for angle of critical deformation in a coal mining area provided by a second embodiment of the present invention;

FIG. 3 is an operation time diagram of different repeat times of an InSAR-based measurement method for angle of critical deformation in a coal mining area provided by a second embodiment of the present invention;

FIG. 4 is a schematic diagram of strike curvature and subsidence curves of an InSAR-based measurement method for angle of critical deformation in a coal mining area provided by a fourth embodiment of the present invention;

FIG. 5 is a schematic diagram of strike angle of critical deformation measurement of an InSAR-based measurement method for angle of critical deformation in a coal mining area provided by a fourth embodiment of the present invention;

FIG. 6 is a schematic diagram of dip curvature and subsidence curves of an InSAR-based measurement method for angle of critical deformation in a coal mining area provided by a fourth embodiment of the present invention; and

FIG. 7 is a schematic diagram of dip angle of critical deformation measurement of an InSAR-based measurement method for angle of critical deformation in a coal mining area provided by a fourth embodiment of the present invention.

### DETAILED DESCRIPTION OF THE EMBODIMENTS

In order to make the aforementioned purposes, features and advantages of the present invention more apparent and comprehensible, detailed descriptions of specific embodiments of the present invention are provided below in conjunction with the appended drawings. Apparently, the described embodiments are only part of the embodiments of the present invention, not all of them. On the basis of the examples of the present invention, all other examples obtained by those of ordinary skill in the art without creative efforts shall fall within the protection scope of the present invention.

A number of specific details are set forth in the description below to provide a thorough understanding for the present invention, however, the present invention may also be implemented in other manners different from those described herein, and those skilled in the art may make similar generalization without departing from the essence of the present invention, therefore, the present invention is not limited by the specific examples disclosed below.

### Embodiment 1

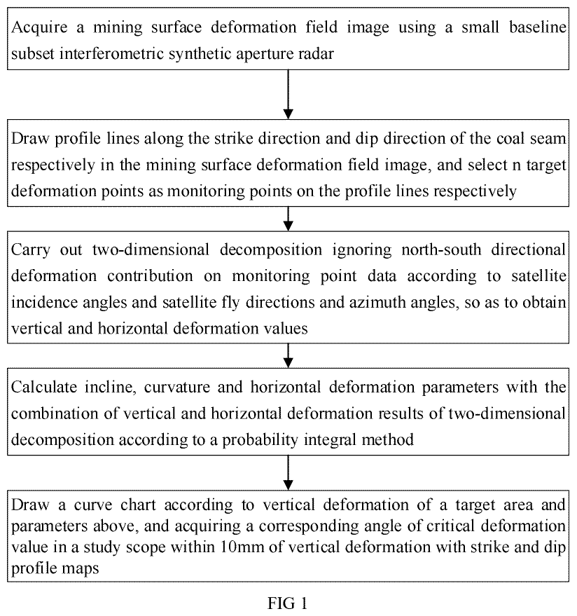

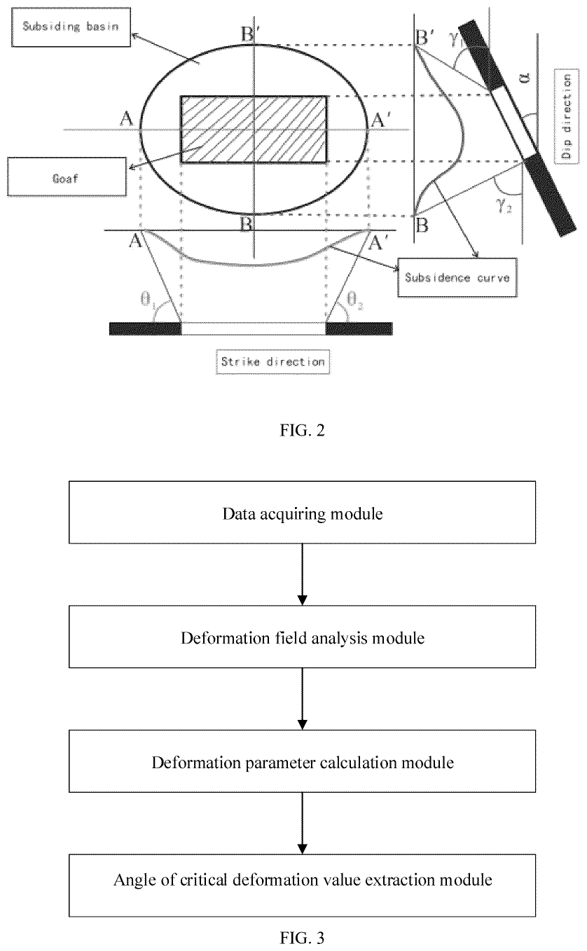

Referring to FIG. 1, as an embodiment of the present invention, an InSAR-based measurement method for angle of critical deformation in a coal mining area is provided, including:
acquiring a mining surface deformation field image using a small baseline subset interferometric synthetic aperture radar;
drawing profile lines along the strike direction and dip direction of the coal seam respectively in the mining surface deformation field image, and selecting n target deformation points as monitoring points on the profile lines respectively;
carrying out two-dimensional decomposition ignoring north-south directional deformation contribution on monitoring point data according to satellite incidence angles and satellite fly directions and azimuth angles, so as to obtain vertical and horizontal deformation values;
calculating incline, curvature and horizontal deformation parameters with the combination of vertical and horizontal deformation results of two-dimensional decomposition according to a probability integral method; and
drawing a curve chart according to vertical deformation of a target area and parameters above, and acquiring a corresponding angle of critical deformation value in a study scope within 10 mm of vertical deformation with strike and dip profile maps.

The acquiring the mining surface deformation field image includes image calibration, interference handling, coherent phase analysis and data interpretation.

The image calibration includes atmospheric calibration and radiation calibration. The interference handling includes calculating interference images at different time points. The coherent phase analysis includes acquiring coherent phase history of each pixel and detecting surface displacement signals. The data interpretation includes acquiring lifting and subsidence phenomena of the target area according to data.

The selecting n target deformation points as monitoring points includes taking the length through the goaf of the strike and dip profile lines of the coal seam, wherein the profile lines are of equal length, so that the number of monitoring points are equal.

Two-dimensional decomposition is expressed as,

$$\{ \begin{matrix}{D}_{{T}_{1} , {T}_{2}} = {d}_{U} cos θ − {d}_{E} sin θ cos ( α − \frac{3}{2} π ) \\ {D}_{{T}_{1}^{′} , {T}_{2}^{′}}^{′} = {d}_{U} cos {θ}^{′} − {d}_{E} sin {θ}^{′} cos ( {α}^{′} − \frac{3}{2} π )\end{matrix} \}$$

wherein θ represents the incidence angle of a satellite image; represents the included angle of the satellite fly direction and the north direction; and α-3/2π represents the included angle of the projection angle and the north direction in the satellite sight direction on the ground. T₁ and T₂ represent the acquisition time of two-scene satellite data of a same ascending; D_{T1,T2} represents deformation of the radar sight direction within the time from T₁ to T₂; d_{U} represents the deformation in the vertical direction; and d_{E} represents the deformation in the horizontal east-west direction. The deformation of the descending radar sight direction is D′_{T1,T2}; T₁′ and T₂′ respectively represent acquisition time of data; θ′ represents an incidence angle of a satellite descending image; and a and a′ respectively represent the included angle of the satellite fly direction and the north direction.

The probability integral method is expressed as,

$$W ( x , z ) = {W}_{0} ( \frac{1}{\sqrt{π}} {\int }_{0}^{\frac{\sqrt{π x}}{{r}_{z}}} {e}^{− {λ}^{2}} d λ + \frac{1}{2} )$$

$$i ( x , z ) = \frac{d W}{d x} = \frac{{W}_{0}}{{r}_{z}} {e}^{\frac{π {x}^{2}}{{r}_{s}^{2}}}$$

$$k ( x , z ) = \frac{d i}{d x} = − \frac{2 {W}_{0} π x}{{r}_{z}^{3}} {e}^{\frac{π {x}^{2}}{{r}_{s}^{2}}}$$

$$U ( x , z ) = {B}_{z} \frac{d W}{d x} = \frac{{B}_{z} {W}_{0}}{{r}_{z}} {e}^{− \frac{π {x}^{2}}{{r}_{s}^{2}}}$$

$$ε ( x , z ) = \frac{d U}{d x} = − \frac{2 {W}_{0} {B}_{z} π x}{{r}_{z}^{3}} {e}^{− \frac{π x 2}{{r}_{s}^{2}}}$$

$${W}_{0} = mq cos α$$

$${r}_{z} = \sqrt{4 A π} = \frac{H}{tan β}$$

wherein W₀ is a maximum surface subsidence value; r_{z} is a main radius of influence; λ is a horizontal integral distance; m is an ore mining depth; q is a subsidence coefficient; α is an ore bed dip; A is a constant; H is a mining depth; and tanβ is a main influence angle tangent value. i represents incline; k represents curvature; U represents a horizontal displacement value; B_{z} represents a horizontal movement coefficient; and ε represents horizontal deformation.

The angle of critical deformation is that under the circumstance of full subsidence, critical deformation values are calculated and dangerous moving boundaries are determined using a group of critical deformation values under current criteria,

$$i = \pm 3 mm / m , ε = \pm 2 mm / m , k = \pm 0.2 ⋆ {10}^{− 3} / m$$

generate cross points, the outermost point of all cross points of the critical deformation values within 10 mm is projected vertically onto a connecting line of a ground point and a boundary point of the goaf, and then the included angle formed by the connecting line and the horizontal line is the angle of critical deformation.

The angle of critical deformation includes that on the basis of taking points on defined angle of critical deformation, if the vertical subsidence curve exceeds 10 mm on the outermost side of the profile, an outermost point of the cross point of the critical deformation curve is selected, and the included angle of the connecting point passing through the point and the outermost cross point of a target coal seam and the horizontal line is the angle of critical deformation.

The angle of critical deformation further includes that when goafs that the profile lines pass through are not consecutive, according to time sections reaching sufficient subsidence, corresponding coal seams and subsidence curve fluctuation trend, a cross point of the critical deformation value is vertically projected onto the ground point, and the included angle of the connecting line of the point and the outermost cross point of the target coal seam and the horizontal line is the angle of critical deformation.

### Embodiment 2

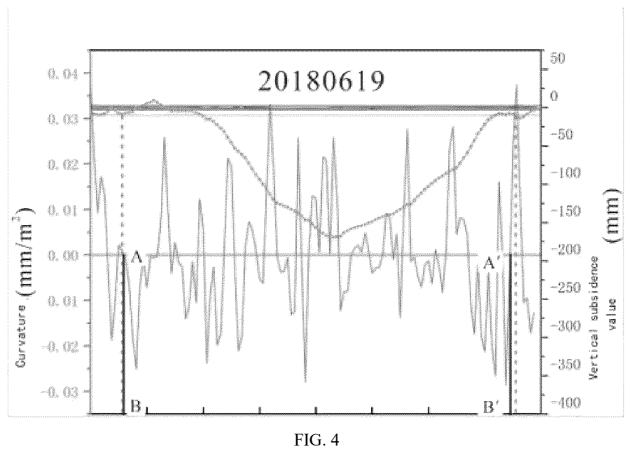

Referring to FIG. 3, as an embodiment of the present invention, an InSAR-based measurement system for angle of critical deformation in a coal mining area is provided, including:
a data acquisition module, a deformation field analysis module, a deformation parameter calculation module and an angle of critical deformation value extraction module.

The data acquisition module is used for acquiring InSAR satellite data, carrying out atmospheric and radiation calibration, calculating interference images at different time points, analyzing coherent phase history of each pixel, and detecting surface displacement signals.

The deformation field analysis module is used for analyzing processed data using the small baseline subset interferometric synthetic aperture radar, extracting surface deformation information, drawing profile lines in coal seam strike and dip directions, and selecting monitoring points.

The deformation parameter calculation module is used for calculating incline, curvature and horizontal deformation parameters based on two-dimensional decomposition results with the probability integral method by examining satellite incidence angles and fly direction and azimuth angles.

The angle of critical deformation value extraction module is used for drawing a curve chart and determining an angle of critical deformation value according to vertical deformation and other parameters obtained through calculation, and illustrating data in graphs.

### Embodiment 3

An embodiment of the present invention, different from the two former embodiments in that:

The above functions, if implemented in the form of software functional units and sold or used as stand-alone products, can be stored in a computer readable storage medium. On the basis of this understanding, the technical solution of the present invention essentially or a part that contributes to the prior art, or a part of the technical solution may be embodied in the form of a software product, and the computer software product is stored in a storage medium and includes a plurality of instructions which are used for enabling a computer device (which may be a personal computer, a server, or a network device, etc.) to execute all or a part of the steps of the methods described in the various examples of the present invention. The storage medium includes: a USB flash disk, a mobile hard disk, a read-only memory (ROM), a random access memory (RAM), a magnetic disk or an optical disk and another medium that can store program codes.

Logics and/or steps expressed in the flow chart or otherwise described herein, for example, may be considered as a sequence table of executable instructions for implementing logical functions, and may be implemented in any computer-readable medium for use by instruction execution systems, apparatuses, or devices (such as computer-based systems, systems including processors, or other systems that may acquire instructions from the instruction execution systems, the apparatuses, or the devices and execute the instructions), or in a combination manner. For the purposes of the specification, “computer-readable medium” can be any device that can contain, store, communicate, propagate or transmit programs for execution by an instruction-executing system, device or equipment, or in combination with these instructions for execution by such a system, device or equipment.

More specific examples (non-exhaustive list) of the computer-readable medium may include the following: an electrical connection (an electronic apparatus) with one or more wires, a portable computer disk case (a magnetic apparatus), a Random Access Memory (RAM), a Read-Only Memory (ROM), an Erasable Programmable Read-Only Memory (EPROM or flash memory), an optical fiber, and a portable Compact Disk Read-Only Memory (CDROM). Furthermore, the computer-readable medium can even be paper or other suitable medium on which the program can be printed, because the program can be obtained in electronic form by, for example, scanning the paper or other medium optically, then editing, interpreting or processing as necessary or in other appropriate ways, and then storing in the computer memory.

It should be understood that, each part of the present invention may be realized by hardware, software, firmware or a combination thereof. In the above implementation manners, a plurality of steps or methods may be realized by software or firmware stored in the memory and executed by the appropriate instruction execution systems. For example, if the plurality of steps or methods are realized by hardware, as in another implementation manner, the plurality of steps or methods may be realized by any one of the following technologies which are well known in the art or a combination thereof: a discrete logic circuit with a logic gate circuit for realizing a logic function for a data signal, an application-specific integrated circuit with an appropriate combinational logic gate circuit, a programmable gate array (PGA), a field-programmable gate array (FPGA), etc.

### Embodiment 4

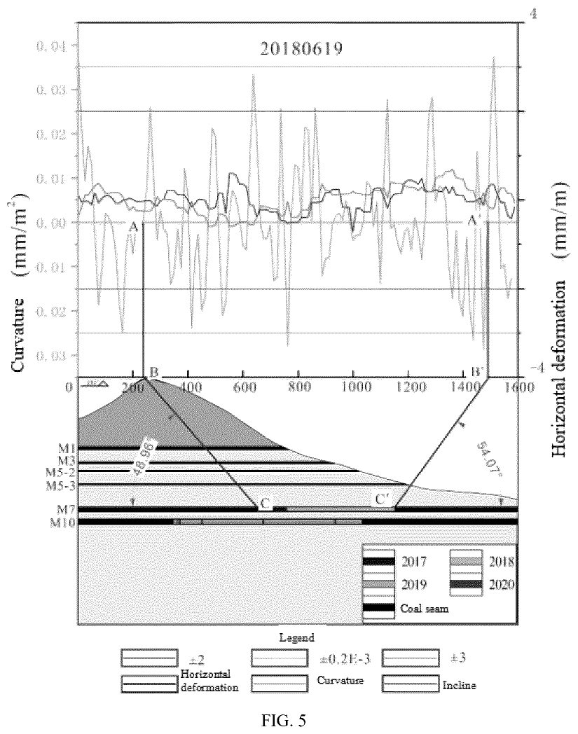

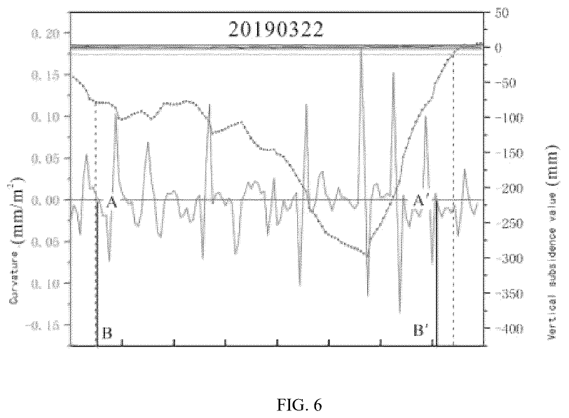

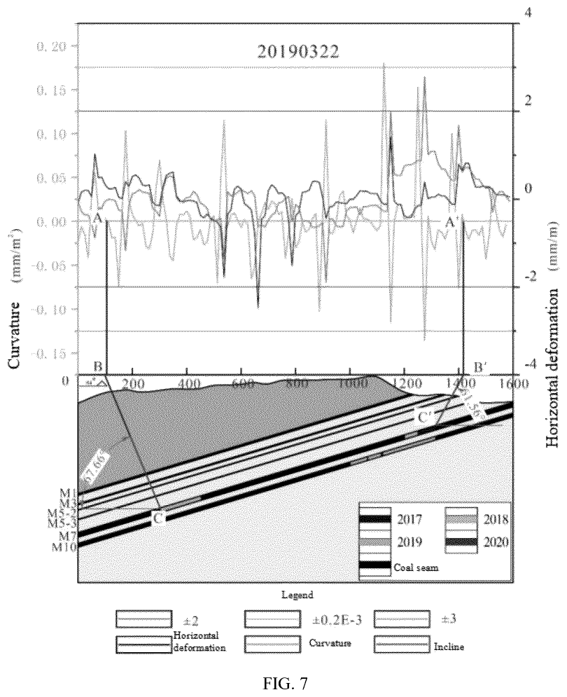

Referring to FIG. 4-7, as an embodiment of the present invention, an InSAR-based measurement method for angle of critical deformation in a coal mining area is provided. To verify the beneficial effects of the present invention, scientific arguments are made through economic benefit calculations and simulation experiments.

The present invention overcomes the drawback that the parameters of mining subsidence parameters can only be obtained through ground monitoring stations or actual measurements. The method based on the integration of SBAS-InSAR technology and the probability integral method can obtain the mining subsidence parameters quickly and accurately.

As shown in FIGS. 4 to 7, the InSAR-based measurement method and system for angle of critical deformation in the coal mining area provided by the present invention, includes setting 128 monitoring points along the strike and dip profiles of the coal seam, carrying out two-dimensional decomposition on data on each monitoring point, calculating three critical deformation curves, and finally, by combining the two corresponding geological profiles drawn with Rhino6, and considering the subsidence curves, the three critical deformation curves, and the geological profiles, obtaining corresponding angle of critical deformation in the mountainous coal mining area according to mining subsidence data, under the condition of single coal seam mining, the strike movement angles are 48.96° and 54.07°, and the dip angles of critical deformation are 67.66° and 61.56° respectively.

It should be noted that the above examples are merely used to explain the technical solutions of the present disclosure and not intended to limit the present disclosure. Although the present disclosure is described in detail with reference to the preferred examples, those of ordinary skill in the art should understand that they can make modifications or equivalent substitutions to the technical solutions of the present disclosure without departing from the spirit and scope of the technical solutions of the present disclosure. These modifications or equivalent substitutions should fall within the scope of the claims of the present disclosure.

What is claimed is:

1. An InSAR-based measurement method for angle of critical deformation in a coal mining area, comprising:
acquiring a mining surface deformation field image using a small baseline subset interferometric synthetic aperture radar;
drawing profile lines along the strike direction and dip direction of the coal seam respectively in the mining surface deformation field image, and selecting n target deformation points as monitoring points on the profile lines respectively;
carrying out two-dimensional decomposition ignoring north-south directional deformation contribution on monitoring point data according to satellite incidence angles and satellite fly directions and azimuth angles, so as to obtain vertical and horizontal deformation values;
calculating incline, curvature and horizontal deformation parameters with the combination of vertical and horizontal deformation results of two-dimensional decomposition according to a probability integral method; and
drawing a curve chart according to vertical deformation of a target area and parameters above, and acquiring a corresponding angle of critical deformation value in a study scope within 10 mm of vertical deformation with strike and dip profile maps.

2. The InSAR-based measurement method for angle of critical deformation in the coal mining area according to claim 1, wherein the acquiring mining surface deformation field image comprises image calibration, interference handling, coherent phase analysis and data interpretation;
image calibration comprises atmospheric calibration and radiation calibration; interference handling comprises calculating interference images at different time points; coherent phase analysis comprises acquiring coherent phase history of each pixel and detecting surface displacement signals; data interpretation comprises acquiring lifting and subsidence phenomena of the target area according to data; and
the selecting n target deformation points as monitoring points comprises taking the length through the goaf of the strike and dip profile lines of the coal seam, wherein the profile lines are of equal length, so that the number of monitoring points are equal.

3. The InSAR-based measurement method for angle of critical deformation in the coal mining area according to claim 2, wherein the two-dimensional decomposition is expressed as:
$$\{ \begin{matrix}{D}_{{T}_{1} , {T}_{2}} = {d}_{U} cos θ − {d}_{E} sin θ cos ( α − \frac{3}{2} π ) \\ {D}_{{T}_{1}^{′} , {T}_{2}^{′}}^{′} = {d}_{U} cos {θ}^{′} − {d}_{E} sin {θ}^{′} cos ( {α}^{′} − \frac{3}{2} π )\end{matrix} \}$$
wherein θ represents the incidence angle of a satellite image; represents the included angle of the satellite fly direction and the north direction; α-3/2π represents the included angle of the projection angle and the north direction in the satellite sight direction on the ground; T₁ and T₂ represent the acquisition time of two-scene satellite data of a same ascending; D_{T1,T2} represents deformation of the radar sight direction within the time from T₁ to T₂; d_{U} represents the deformation in the vertical direction; d_{E} represents the deformation in the horizontal east-west direction; the deformation of the descending radar sight direction is D′_{T1,T2}; T₁′ and T₂′ respectively represent acquisition time of data; θ′ represents an incidence angle of a satellite descending image; and a and a′ respectively represent the included angle of the satellite fly direction and the north direction.

4. The InSAR-based measurement method for angle of critical deformation in the coal mining area according to claim 3, wherein the probability integral method is expressed as:
$$W ( x , z ) = {W}_{0} ( \frac{1}{\sqrt{π}} {\int }_{0}^{\frac{\sqrt{π x}}{{r}_{z}}} {e}^{− {λ}^{2}} d λ + \frac{1}{2} )$$
$$i ( x , z ) = \frac{d W}{d x} = \frac{{W}_{0}}{{r}_{z}} {e}^{\frac{π {x}^{2}}{{r}_{s}^{2}}}$$
$$k ( x , z ) = \frac{d i}{d x} = − \frac{2 {W}_{0} π x}{{r}_{z}^{3}} {e}^{\frac{π {x}^{2}}{{r}_{s}^{2}}}$$
$$U ( x , z ) = {B}_{z} \frac{d W}{d x} = \frac{{B}_{z} {W}_{0}}{{r}_{z}} {e}^{− \frac{π {x}^{2}}{{r}_{s}^{2}}}$$
$$ε ( x , z ) = \frac{d U}{d x} = − \frac{2 {W}_{0} {B}_{z} π x}{{r}_{z}^{3}} {e}^{− \frac{π x 2}{{r}_{z}^{2}}}$$
$${W}_{0} = mq cos α$$
$${r}_{z} = \sqrt{4 A π} = \frac{H}{tan β}$$
wherein W₀ is a maximum surface subsidence value; r_{z} is a main radius of influence; λ is a horizontal integral distance; m is an ore mining depth; q is a subsidence coefficient; α is an ore bed dip; A is a constant; H is a mining depth; tanβ is a main influence angle tangent value; i represents incline; k represents curvature; U represents a horizontal displacement value; B_{z} represents a horizontal movement coefficient; and & represents horizontal deformation.

5. The InSAR-based measurement method for angle of critical deformation in the coal mining area according to claim 4, wherein the angle of critical deformation is that under the circumstance of critical mining, critical deformation values are calculated and dangerous moving boundaries are determined using a group of critical deformation values under current criteria,
$$i = \pm 3 mm / m , ε = \pm 2 mm / m , k = \pm 0.2 ⋆ {10}^{− 3} / m$$
generate cross points, the outermost point of all cross points of the critical deformation values within 10 mm is projected vertically onto a connecting line of a ground point and a boundary point of the goaf, and then the included angle formed by the connecting line and the horizontal line is the angle of critical deformation.

6. The InSAR-based measurement method for angle of critical deformation in the coal mining area according to claim 5, wherein the angle of critical deformation comprises that on the basis of taking points on defined angle of critical deformation, if the vertical subsidence curve exceeds 10 mm on the outermost side of the profile, an outermost point of the cross point of the critical deformation curve is selected, and the included angle of the connecting point passing through the point and the outermost cross point of a target coal seam and the horizontal line is the angle of critical deformation.

7. The InSAR-based measurement method for angle of critical deformation in the coal mining area according to claim 6, wherein the angle of critical deformation further comprises that when goafs that the profile lines pass through are not consecutive, according to time sections reaching sufficient subsidence, corresponding coal seams and subsidence curve fluctuation trend, a cross point of the critical deformation value is vertically projected onto the ground point, and the included angle of the connecting line of the point and the outermost cross point of the target coal seam and the horizontal line is the angle of critical deformation.

8. A system of the InSAR-based measurement method for angle of critical deformation in the coal mining area according to claim 7, comprising: a data acquisition module, a deformation field analysis module, a deformation parameter calculation module and an angle of critical deformation value extraction module,
wherein the data acquisition module is used for acquiring InSAR satellite data, carrying out atmospheric and radiation calibration, calculating interference images at different time points, analyzing coherent phase history of each pixel, and detecting surface displacement signals;
the deformation field analysis module is used for analyzing processed data using the small baseline subset interferometric synthetic aperture radar, extracting surface deformation information, drawing profile lines in coal seam strike and dip directions, and selecting monitoring points;
the deformation parameter calculation module is used for calculating incline, curvature and horizontal deformation parameters based on two-dimensional decomposition results with the probability integral method by examining satellite incidence angles and fly direction and azimuth angles; and
the angle of critical deformation value extraction module is used for drawing a curve chart and determining an angle of critical deformation value according to vertical deformation and other parameters obtained through calculation, and illustrating data in graphs.

9. A computer device, comprising a memory and a processor, wherein the memory is used for storing computer programs; and the steps of the InSAR-based measurement method for angle of critical deformation in the coal mining area according to claim 7 are achieved when the computer programs are executed by the processor.

10. A computer readable storage medium, with computer programs stored thereon, wherein the steps of the InSAR-based measurement method for angle of critical deformation in the coal mining area according to claim 7 are achieved when the computer programs are executed by the processor.
